(19) United States
(12) Patent Application Publication
(10) Pub. No.: US 2004/0027644 A1
(43) Pub. Date: Feb. 12, 2004

(54) Programmable photonic device and method

(75) Inventor: Floyd A. Fazi JR., Ft. Worth, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(73) Assignee: Lockheed Martin Corporation, Bethesda, MD

(21) Appl. No.: 10/215,771

(22) Filed: Aug. 9, 2002

(51) Int. Cl. G02F 1/29; G02B 26/08

(52) U.S. Cl. 359/298

(57) ABSTRACT

A programmable photonic device includes a plurality of optical functional elements and at least one programmable signal path coupled to at least one of the optical functional elements. The signal path is adapted to convey an optical signal along the signal path. The device also includes at least one directional element adapted to direct the optical signal to the signal path.

### TECHNICAL FIELD OF THE INVENTION

The present invention relates generally to the field of optical devices and, in particular, to a programmable logic device and method.

### BACKGROUND OF THE INVENTION

Programmable logic devices or gate arrays are becoming an increasingly popular design tool because of the configurable nature of the digital circuits. One example of a programmable logic device contains areas of programmable logic elements deposited on the device in a two-dimensional array of intersecting rows and columns. These devices generally contain a core set of electrical logic building blocks which may be programmed by a user. Thus, different circuits may be integrated into a single chip allowing a common design to be manufactured.

The development of photonic integrated circuits has also led to several different designs of optical circuits. These optical circuits may also be incorporated into application specific integrated circuits allowing a common design to be manufactured. However, there remains a limited market for these photonic integrated circuit designs. Thus, producing these photonic devices remains generally cost prohibitive.

### SUMMARY OF THE INVENTION

A need has arisen to solve the high costs and limited design availability associated with optical application specific photonic integrated circuits.

In accordance with an embodiment of the present invention, a programmable logic device includes a plurality of optical functional elements and at least one programmable signal path coupled to at least one of the optical functional elements. The programmable signal path is adapted to convey an optical signal along the signal path. The device also includes at least one directional element adapted to direct the optical signal to the signal path.

In accordance with another embodiment of the invention, a method for manufacturing a programmable logic device includes providing a plurality of optical functional elements and forming a programmable signal path adapted to convey an optical signal to at least one of the functional elements. The method also includes providing a directional element adapted to direct the optical signal to the signal path.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a diagram illustrating a programmable photonic device in accordance with an embodiment of the present invention; and

FIG. 2 is a diagram illustrating a programmable photonic device in accordance with another embodiment of the present invention.

### DETAILED DESCRIPTION OF THE DRAWINGS

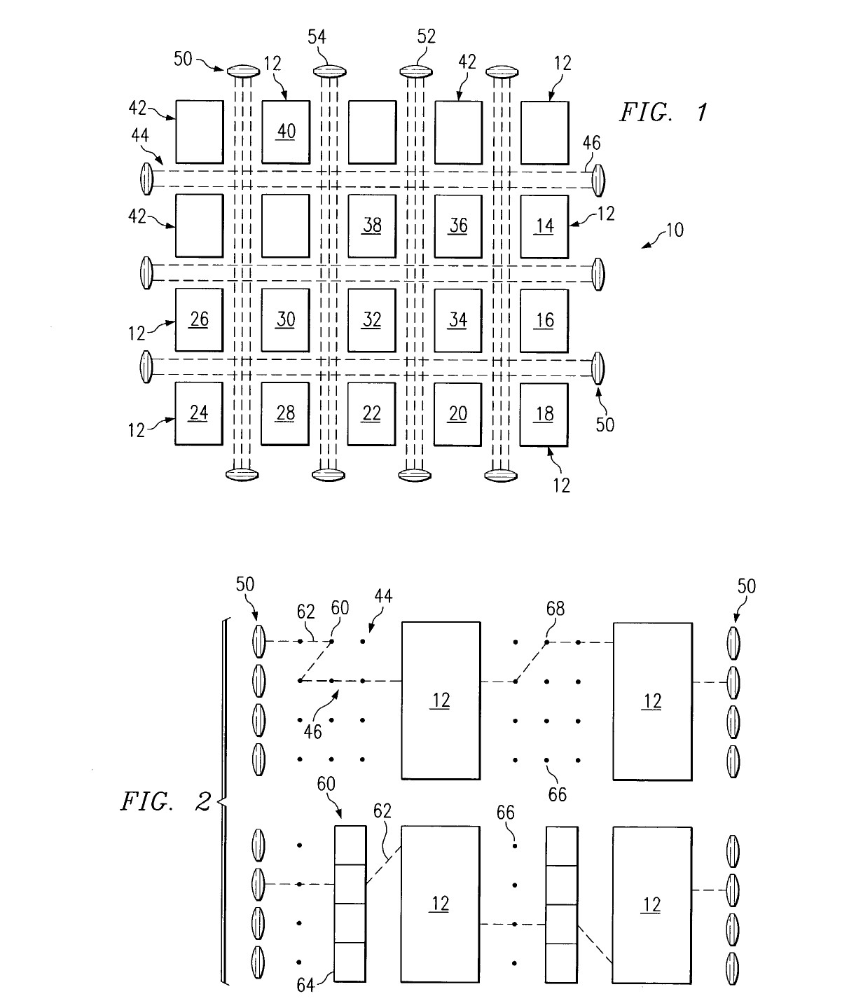

The preferred embodiment of the present invention and its advantages are best understood by referring to FIGS. 1 and 2 of the drawings, like numerals being used for like and corresponding parts of the various drawings.

FIG. 1 is a diagram illustrating a programmable photonic device 10 in accordance with an embodiment of the present invention. In the illustrated embodiment, device 10 includes one or more optical interconnect functional elements 12. For example, in the illustrated embodiment, functional elements 12 comprise an electrical/optical converter 14, a splitter 16, a filter 18, a coupler 20, an amplifier 22, an attenuator 24, and a laser 26. However, it should be understood that functional elements 12 may also include other types of elements for performing a desired function or operation in connection with an optical signal. In this embodiment, functional elements 12 may also comprise a tunable filter 28, a tunable splitter 30, a tunable laser 32, a tunable coupler 34, a tunable amplifier 36, a tunable attenuator 38, and a tunable electrical/optical converter 40. Accordingly, it should also be understood that functional elements 12 may comprise other types of tunable or adjustable elements for performing a desired function or operation in connection with an optical signal. Device 10 may also include one or more logic elements 42.

Device 10 also comprises a programmable interconnect network 44 having one or more programmable signal paths 46 for conveying optical signals within device 10. For example, each element 12 and/or element 42 may be coupled to another element 12 and/or element 42 or to an input or output of device 10 via one or more paths 46. Optical signals may be directed to paths 46 from external sources via one or more directional elements 50. Directional elements 50 may comprise a lens 52, a collimator 54, or any combination thereof, or other optical elements used to focus or otherwise direct optical signals in a desired direction.

In operation, a user of device 10 may program network 44 to route optical signals along one or more desired signal paths 46. Network 44 may be configured to accommodate repeated programming operations or may be configured such that only a single programming operation may be performed. As described above, network 44 may be programmed to direct optical signals to or from one or more functional elements 12. For example, lasers 26 and/or tunable lasers 32 may be used to generate an optical signal within device 10. Other functional elements 12 of device 10 may be used to perform a desired function on an optical signal, such as splitting the optical signal into a plurality of discrete signals, attenutaing an optical signal, coupling a plurality of optical signals into a single optical signal, filtering a desired portion of the optical signal, and/or other operations associated with an optical signal.

FIG. 2 is a diagram illustrating device 10 in accordance with an embodiment of the present invention. As illustrated in FIG. 2, programmable interconnect network 44 includes one or more switches 60 for variably directing an optical signal 62 to a desired path 46. For example, switches 60 may comprise a micro-electric-mechanical system switch 64 to program paths 46 between elements 12 and/or elements 42. Switches 60 may also comprise one or more reflective elements 66 for programming paths 46 between elements 12 and/or elements 42. For example, reflective elements 66 may comprise one or more pop-up mirrors 68 or other programmable optical reflective or guiding elements for conveying optical signal 62 along a desired path 46.

Device 10 may be configured as a single-layer structure or as a multi-layer sandwich structure. Accordingly, network 44 may be configured using vias or other connecting structure to route optical signals 62 between various layers of device 10. Additionally, device 10 may be configured such that paths 46 comprise silicon grooves or other structural routing channels formed on device 10. However, paths 46 may also comprise “free-space” pathways for routing optical signals 62. For example, one or more reflective elements 66 may be used to form a “free-space” path 46 on device 10 for routing optical signals 62 between elements 12 and/or elements 42.

Accordingly, the present invention provides a programmable photonic device 10 accommodating a variety of design applications by allowing a user of device 10 to rapidly design optical systems to meet a variety of requirements. Additionally, the present invention provides a programmable photonic device 10 that may be used in a variety of optical applications, such as, but not limited to, fiber optic bus interface modules, fiber optic sensor interfaces, and telecommunications switches.

What is claimed is:

1. A programmable photonic device, comprising:
a plurality of optical functional elements;
at least one programmable signal path coupled to at least one of the optical functional elements and adapted to convey an optical signal along the signal path; and
at least one directional element adapted to direct the optical signal to the signal path.

2. The device of claim 1, wherein at least one of the optical functional elements comprises a tunable optical functional element.

3. The device of claim 1, wherein the programmable signal path comprises at least one reflective element.

4. The device as set forth in claim 3, wherein the reflective element comprises a pop-up mirror.

5. The device as set forth in claim 1, wherein at least one of the functional elements comprises a tunable laser.

6. The device as set forth in claim 1, wherein at least one of the functional elements comprises a tunable filter.

7. The device as set forth in claim 1, wherein at least one of the functional elements comprises an electrical/optical converter.

8. The device as set forth in claim 1, wherein the programmable signal path comprises at least one micro-electric-mechanical switch.

9. The device as set forth in claim 1, wherein at least one of the functional elements comprises a splitter.

10. The device as set forth in claim 1, wherein at least one of the functional elements comprises a filter.

11. The device as set forth in claim 1, wherein at least one of the functional elements comprises a coupler.

12. The device as set forth in claim 1, wherein at least one of the functional elements comprises an amplifier.

13. The device as set forth in claim 1, wherein at least one of the functional elements comprises an attenuator.

14. The device as set forth in claim 1, wherein at least one of the functional elements comprises a tunable splitter.

15. The device as set forth in claim 1, wherein at least one of the functional elements comprises a tunable coupler.

16. A programmable photonic device comprising:
means for directing an optical signal to a signal path;
means for performing an optical interconnect function on the optical signal; and
means for programming the signal path to convey the optical signal to the function means.

17. The device as set forth in claim 16, wherein the function means comprises a tunable means for performing an optical interconnect function.

18. The device as set forth in claim 17, the tunable function means selected from the group consisting of a tunable splitter, a tunable laser, a tunable filter, a tunable electrical/optical converter, a tunable coupler, a tunable amplifier, and a tunable attenuator.

19. The device as set forth in claim 16, wherein the means for programming comprises at least one pop-up mirror.

20. The device as set forth in claim 16, wherein the means for programming comprises at least one micro-electric-mechanical switch.

21. The device as set forth in claim 16, wherein the function means comprises a splitter.

22. The device as set forth in claim 16, wherein the function means comprises an amplifier.

23. The device as set forth in claim 16, wherein the function means comprises a filter.

24. The device as set forth in claim 16, wherein the function means comprises a coupler.

25. The device as set forth in claim 16, wherein the function means comprises an electrical/optical converter.

26. A method for manufacturing a programmable photonic device, comprising:
providing a plurality of optical functional elements;
forming a programmable signal path adapted to convey an optical signal to at least one of the functional elements; and
providing a directional element adapted to direct the optical signal to the signal path.

27. The method of claim 26, wherein forming the programmable signal path comprises providing at least one reflective element.

28. The method of claim 27, wherein providing at least one reflective element comprises providing at least one pop-up mirror.

29. The method of claim 26, wherein providing the functional elements comprises providing at least one tunable optical functional element.

30. The method of claim 29, wherein providing at least one tunable element comprises selecting at least one tunable element from the group consisting of a tunable splitter, a tunable laser, a tunable filter, a tunable electrical/optical converter, a tunable coupler, a tunable amplifier, and a tunable attenuator.

31. The method of claim 26, wherein providing the functional elements comprises providing at least one splitter.

32. The method of claim 26, wherein providing the functional elements comprises providing at least one filter.

33. The method of claim 26, wherein providing the functional elements comprises providing at least one coupler.

34. The method of claim 26, wherein providing the functional elements comprises providing at least one amplifier.

35. The method of claim 26, wherein providing the functional elements comprises providing at least one electrical/optical converter.
